(19) United States
(12) Patent Application Publication
(10) Pub. No.: US 2020/0315129 A1
(43) Pub. Date: Oct. 8, 2020

(54) Wall-Mounted Shelf for Pets

(71) Applicant: Steve Kumetz, Los Angeles, CA (US)

(72) Inventor: Steve Kumetz, Los Angeles, CA (US)

(21) Appl. No.: 16/839,078

(22) Filed: Apr. 3, 2020

Related U.S. Application Data
(60) Provisional application No. 62/829,623, filed on Apr. 4, 2019.

(51) Int. Cl. A01K 1/035; A01K 15/02

(52) U.S. Cl. CPC A01K 1/035; A01K 15/024

(57) ABSTRACT

The present invention provides an elongated wall-mounted animal perch made from layers of pre-shaped laminated cellulous sheet stock, secured to each other along a longitudinal axis, using an appropriate adhesive, or mechanical tension. According to the invention, select panels of cellulous sheet stock include a predetermined cleat shape cutout so that after the individual panels are collectively laminated to form a solid shelf structure, a functional mounting cleat is effectively formed integrally into a rear surface of the shelf. The integrally-formed mounting cleat is sized and shaped to snugly and selectively engage a wall-mounted cleat, during mounting. The two cleats engage to support the animal shelf firmly against a wall surface while remaining hidden from view. According to a second embodiment, two opposing shelf-mount cleats with a common shape are integrally formed within the same recess formed on the rear surface of the shelf. The opposing cleats allow the shelf to be quickly and easily inverted and re-secured to the same wall-mounted cleat. This provides the user to select different surfaces of the shelf, or to provide a new scratching surface, depending on the details of the particular shelf.

### CLAIM OF PRIORITY

This application claims priority from U.S. Provisional Patent Application No. 62/829,623, filed Apr. 4, 2019, entitled: “Wall-Mounted Shelf for Pets,” the contents of which are incorporated herein, in their entirety.

### BACKGROUND OF THE INVENTION

### 1. Field of the Invention

The present invention generally relates to wall-mounted shelves and ledges, and more particularly, to such wall-mounted products which include features directed to specific needs of a healthy domestic house cat.

### 2. Description of the Prior Art

a) Perching:

Domesticated cats living freely within a residence, such as a house or apartment, typically and frequently enjoy climbing to a high vantage point, for exercise, amusement, or perhaps by providing a feeling of safety and comfort. Normally, ordinary furniture, drapes, and other commonplace household objects meet this need. However, such objects are not designed for this type of use, and quickly become damaged after a cat uses them to climb.

To this end, several different types of wall-mounted shelves dedicated to domesticated cats have been developed and are commercially available today. Most of them rely on a support structure made from solid wood or metal which is secured to a wall surface using appropriate fasteners. These wall-mounted shelves further typically include an insert, depending on the specific use, including a cushion insert, such as a pillow or wrapped foam.

b) Scratching:

Cats are energetic, curious animals who have retained some tendencies of their genetic past. Cats in the wild regularly scratch logs, and trees to mark their territory. The paws of both wild and domesticated cats includes scent glands that release a signature scent onto everything they scratch. A form of communication.

As cat owners have quickly learned, domesticated cats continued this instinctual scratching habit of their feline relatives to their new environment, indoors.

Unfortunately, owing to the dearth of trees and logs typically found in a person's home, indoor cats have found substitute objects to scratch, pretty much anything including furniture legs, upholstered panels and cushions, walls, door frames and doors, carpets and beds. To prevent, or discourage a cute indoor cat from ripping apart all of the owner's belongings, cat owners quickly train their indoor cat to use a so-called scratching post. A scratching post is a support structure that is typically wrapped with a piece of sacrificial carpet or a length of rope. The cat can learn to scratch the post, as if it were a tree log and thereby save the owner's furniture, house, and sanity.

There are many scratching-post products commercially available today that are designed to provide a scratching surface for an indoor cat to enjoy. Most of these are self-standing structures and include a base and a riser. The riser is often cylindrical and wrapped with carpet or rope. The cat can stand upright on the base and use the wrapped carpet or rope as a scratching surface for his claws. Often, such products further include a cubby into which a cat may find secured comfort.

Another form a scratching-post is a cat shelf or cat ledge (hereinafter referred to as a “cat shelf”) which may be self-supporting, such as a box-like structure onto which a cat may jump, climb and otherwise play, as well as scratch. The cat shelf may also be mounted to a wall surface and may include more than one platforms at varying heights from the floor. This type of structures provides a cat with a fun climbing wall, wherein the cat may jump from level to level and use one of the platforms or shelves as a resting spot, or as a scratching surface, depending on what the particular shelf is made from.

As mentioned in the above background of the prior art section of this patent application, these prior art shelves are relatively expensive and include a heavy internal support structure, requiring that the ledge or shelf be secured to only the strongest portion of conventional house framing, the vertical studs. Conventional through-holes are provided in these shelves to receive screws or bolts for directly securing the structure to the studs of a wall. This conventional securing method may be effective, but it limits where the user may mount the cat shelf.

The support structure of these conventional shelves are typically rigid and directly support the scratching material. The support structure may be made from solid wood, metal or in some cases, very thick cardboard, such as the type of cardboard used as core-tubes for new carpeting and such. Regardless of the material, the support structure of conventional cat shelves generally dictates the shape of the scratching surface.

Some problems with these conventional cat-perch shelving products are that they are expensive, they are heavy and are relatively difficult to install. These shelves are simple in construction and typically rely on simple straight-through fasteners to secure them to a wall. The fasteners, such as lag-bolts or threaded wood screws are exposed. Owing to the weight, expected load and expected use of the shelves (repeated impact by cats jumping on and off all day long, everyday for years) the fasteners are driven directed into spaced vertical wall studs to ensure sufficient and long-lasting holding power. This limits where the cat-owner can mount the shelf on their wall.

Cardboard and corrugated cardboard are well known stock materials and are used in thousands of products today. The first form of corrugated, or pleated paper was patented in 1871 under U.S. Pat. No. 122,023 to Jones. This paper was soon to be improved upon under U.S. Pat. No. 150,588 to Long which issued in 1874. The patent to Long discloses a filler layer, which could be corrugated board, with liner sheets disposed on each side. This is essentially the corrugated cardboard that we know and use today.

With the advent of corrugated cardboard and the recognition of its associated strength, corrugated boxes and containers began replacing wooden crates and the like.

### SUMMARY OF THE INVENTION

The present invention provides an elongated wall-mounted animal perch made from layers of pre-shaped laminated cellulous sheet stock, secured to each other along a longitudinal axis, using an appropriate adhesive, or mechanical tension. According to the invention, select panels of cellulous sheet stock include a predetermined cleat shape cutout so that after the individual panels are collectively laminated to form a solid shelf structure, a functional mounting cleat is effectively formed integrally into a rear surface of the shelf. The integrally-formed mounting cleat is sized and shaped to snugly and selectively engage a wall-mounted cleat, during mounting. The two cleats engage to support the animal shelf firmly against a wall surface while remaining hidden from view. According to a second embodiment, two opposing shelf-mount cleats with a common shape are integrally formed within the same recess formed on the rear surface of the shelf. The opposing cleats allow the shelf to be quickly and easily inverted and re-secured to the same wall-mounted cleat. This provides the user to select different surfaces of the shelf, or to provide a new scratching surface, depending on the details of the particular shelf.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is a first object of the present invention to provide a wall-mounted cat shelf that overcomes the deficiencies of the prior art.

It is a second object of the present invention to provide such a wall-mounted cat shelf that is relatively inexpensive to manufacture.

It is another object of the present invention to provide a wall-mounted cat shelf that is based on a stacked-laminate construction.

It is another object of the present invention to provide a wall-mounted cat shelf that is easy to secure to a wall surface in any location.

It is yet another object of the present invention to provide a wall-mounted cat shelf that can be quickly and easy mounted to a wall surface in any of at least two orientations.

These and other objects of the present invention will become readily apparent upon further review of the following specification and drawings.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a cat shelf, shown mounted to a wall surface, including an exemplary cat relaxing thereon, according to a first embodiment of the invention;

FIG. 2 is a perspective assembly view of the cat shelf of FIG. 1, showing details of the internal construction, including three guide rods and a plurality of precut shelf panels, according to the first embodiment of the invention;

FIG. 3 is a rear perspective view of the cat shelf of FIG. 1, showing a rear surface including an integral shelf-mount cleat and a wall-mount cleat, according to the first embodiment of the invention, wherein the wall-mount cleat is shown engaged with the shelf-mount cleat, but not yet secured to a wall surface;

FIG. 4 is a perspective view of a wall-mounted cleat, according to the invention;

FIG. 5 is a partial side view of the cat shelf of FIG. 1, showing details of the integral shelf-mount cleat and the wall-mount cleat, according to the invention, wherein the cat shelf is not yet engaged with the wall-mount cleat;

FIG. 6 is a partial side view of the cat shelf of FIG. 5, showing details of an integral shelf-mount cleat and a wall-mount cleat, according to the invention, wherein the cat shelf is engaged with the wall-mount cleat;

FIG. 7 is a perspective view of a panel used to make the cat shelf of FIG. 1, according to the invention;

FIG. 8 is a perspective view of a panel used to make cat shelf having a different shape which allows for an inverted orientation;

FIG. 9 is a perspective view of an exemplary cat shelf, according to a third embodiment of the invention, wherein each precut shelf panel is specifically shaped to introduce a featured contour when collectively assembled; and

FIG. 10 is a perspective of a cat shelf, according to yet another embodiment of the invention, wherein a hollow cavity is left accessible from each side of the shelf.

### DETAILED DESCRIPTION OF THE EMBODIMENTS

By way of introduction, the present invention is a new type of wall-mounted shelf specifically designed to support and entertain domesticated cats. The present shelf is made up of a plurality of precut panels (or sheets), secured to each other, face to face to form a solid 3-d shape. Each panel includes a shaped mounting arrangement which allows the assembled shelf to easily mount to a wall surface.

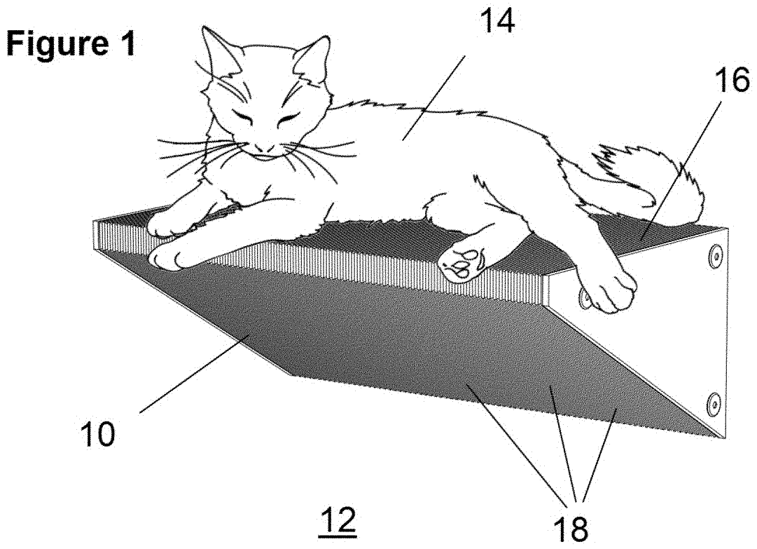

Referring to FIG. 1, a cat shelf 10, according to a first embodiment of the present invention is shown, illustratively mounted to a wall surface 12. A representative cat 14 is shown relaxing on an upper supporting surface 16 of shelf 10. According to the present invention, cat shelf 10 may be made from any of many materials, but is preferably made from corrugated type cardboard, of the type typically used to construct conventional shipping boxes. As is well known, corrugated cardboard (sometimes called: “corrugated fiberboard,” or just “corrugate”) is made by fluting a first sheet of paper and then adhering the peak-portions of the fluted sheet to opposing flat sheets of paper, or fiberboard (which is just a bonded layer of random cellulous fibers). The resulting “paper sandwich” laminate is structurally rigid and relatively lightweight, and is therefore a preferred material for use in many different products, and is also readily available as a recycled material, and relatively inexpensive. Furthermore, paper-based cat products can be used to train a cat to direct his angst and scratching tendencies to the paper cat shelf, and not more valuable furniture items throughout the owner's house. The flutes of the corrugate result in open tubular ends terminating at each opposing edge of the panel. The open ends of the tubular flutes provide an open texture that is both rugged and forgiving to abrasion, a perfect scratching surface for the cat.

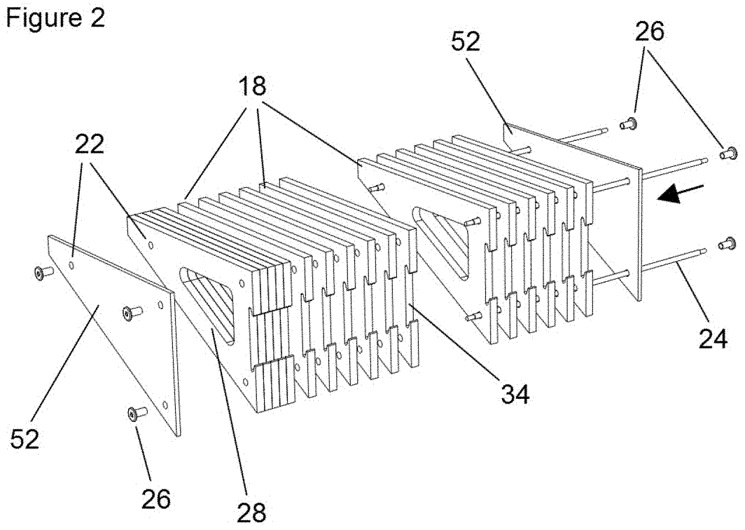

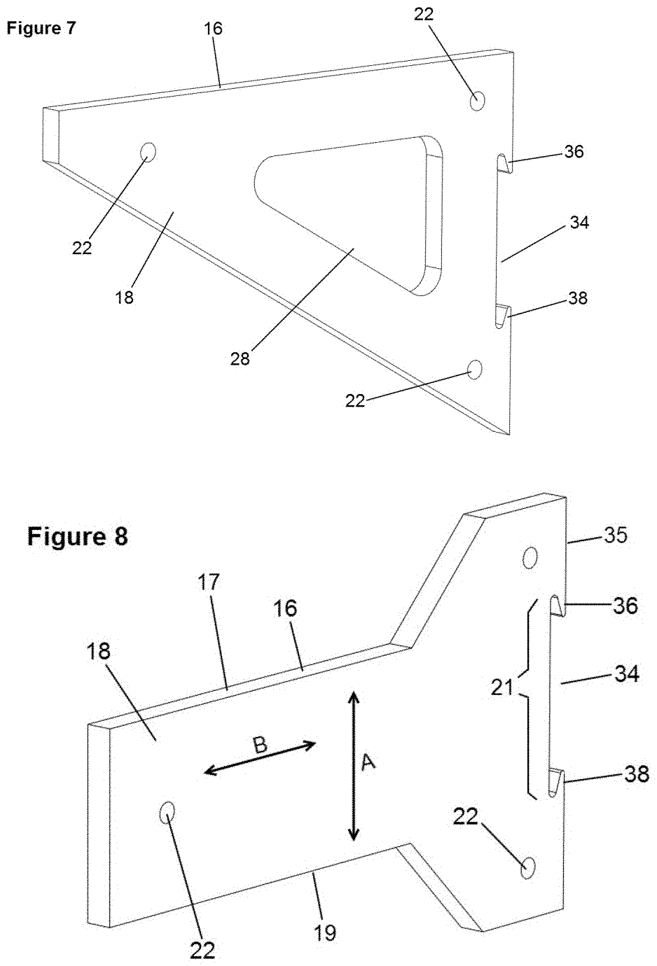

According to the present invention, referring to FIGS. 2, 7, and 8, the present shelf 10 is made from a plurality of precut shelf panels 18. Each panel 18, shown in FIG. 8, for example, is preferably made from a predetermined thickness and shape of corrugated cardboard (new and recycled cardboard can be used, but new cardboard is preferred here) which is stamp-cut using well known cutting techniques, such as rotary steel-rule die cutting. Each panel is generally planar and thereby defines two opposing faces and a peripheral interposed edge. Panels 18 may be made from other materials, such as plastic and wood and may collectively all be identical in material, or may differ from panel to panel. Also, without departing from the gist of the invention, each panel 18 of a particular cat shelf 10 may be the same or of different thickness. According to this first embodiment of the invention, and as described in greater detail below, each panel 18 preferably has the same shape and thickness and is made of the same material, corrugated cardboard. Panels 18, as shown in the accompanying figures are generic and appear solid for reasons of clarity. As mentioned above, panels 18 may be made from a variety of materials, including solid materials, and more “hollow” or open materials, such as corrugated cardboard. In the latter case, the “grain” (or direction of the flutes) of the corrugate may be oriented in any direction, but are preferably oriented vertically with the corrugate flutes perpendicular to upper supporting surface 16, as illustrated by Arrow A, in FIG. 8. The flutes may also be oriented horizontally, as illustrated by Arrow B, in FIG. 8.

Each cut panel 18 defines an upper edge 17, a rear edge 35 and a lower edge 19, as shown in FIG. 8. As described in greater detail below and according to the invention, a cleat profile cutout 21 is integrally formed (that is, cutout from each panel) along rear edge 35 of each panel 18. Cleat profile cutout 21 may include a single upper cleat, or two opposing cleats (mirror opposites of each other), as shown in FIG. 8.

After panels 18 are cut to shape, the individual cut panels 18 are then assembled side to side, as shown in FIG. 2, so that a predictable elongated 3-dimensional shelf shape laminate is created, as shown in FIGS. 1, 3, 9, and 10. In this first embodiment, shown in FIGS. 1 and 2, the 3-dimensional form of cat shelf 10 includes a sectional shape that is identical to the shape of any one of panels 18, and includes a length generally equal to the mathematical product of each panel thickness and the number of panels in the assembly. The assembly of panels 18 makes up the basic shelf 10, as shown in FIG. 1, and defines upper surface 16, on which a cat may reside, scratch or play (as illustrated in FIG. 1), and further defines a rear surface 20, whose shape and function will be described in greater detail below. The face to face arrangement of panels 18 purposely ensures that open ends of each internal fluted edge of each panel 18 collectively provides a somewhat rough upper surface 16, sufficiently rough to satisfy the scratching tendencies of cat 14, but preferably not so rough as to be uncomfortable for the cat to sit or lay on. Therefore, upper surface 16 provides both a scratching surface and a surface on which cat 14 may rest or perch.

Referring now to FIG. 2, wherein shelf 10 is shown as an exploded assembly. According to this first embodiment, and as shown in the figure, shelf panels 18 are arranged side-by-side (i.e., face against face) and each includes at least one registration bore 22, so that all respective registration bores 22 can be aligned with each other. When panels 18 are assembled side by side, the registration bores 22 collectively define an elongated alignment bore that extends the length of shelf 10.

According to the first embodiment of the invention and again referring to FIG. 2, at least one guide rod 24 (three are shown in FIG. 2) for each elongated alignment bore is used to receive the registration bores 22 of each panel 18 (like a skewer collecting pieces of meat and veggies for a shish kabob) so that an assembly of panels 18 is created. Each guide rod is preferably made from steel and includes threaded ends. It should be noted that although a rigid guide rod 24 is preferred to hold panels 18 aligned and in compression, other methods may be used, including the use of an elastic member (e.g., a rubber band) that is positioned within each elongated bore and held in tension so that the interposed panels 18 will be compressed and the cat shelf 10 will retain its 3-dimensional shape.

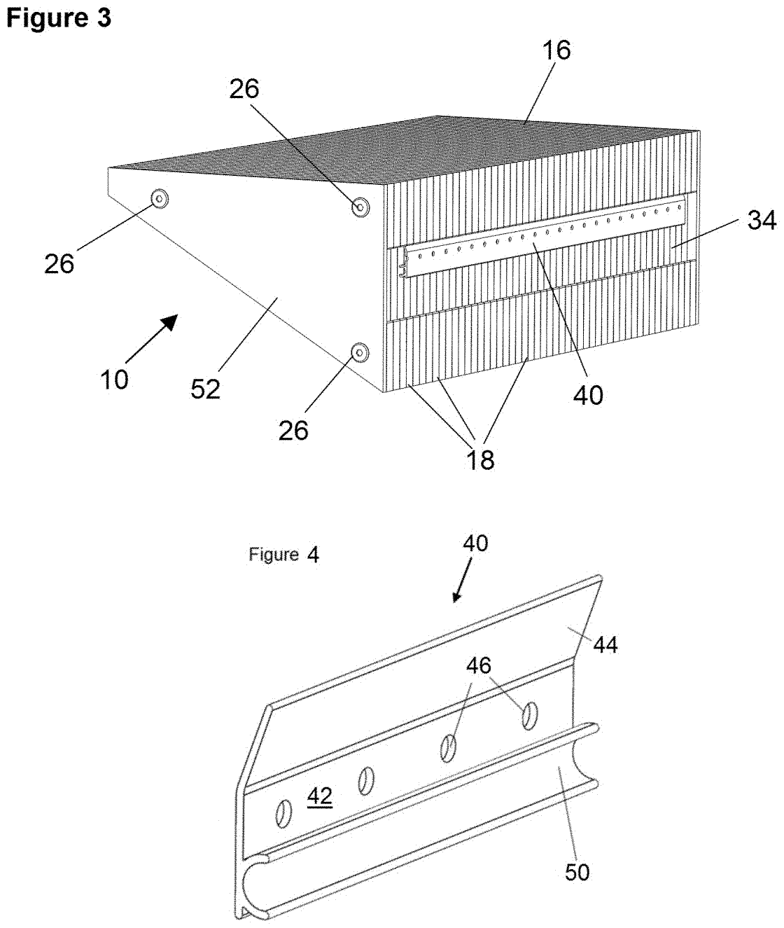

As shown in FIG. 3, once a select number of panels 18 have been assembled onto at least one guide rod 24, appropriately sized end nuts 26 are secured to the threaded ends of each guide rod 24 and tightened so that the collected interposed panels 18 located on the guide rods are firmly compressed together (the guide rod can alternatively be a guide tube with threaded female ends which receive threaded bolts at each end, in place of nuts 26). This ensures that a firm and solid structure of compressed panels is established, a structure that is suitable for mounting to wall surface 12 and supporting the weight of cat 14.

According to the present invention, each panel 18 may take on any shape, such as the generally triangular shape shown in FIGS. 1-4. As mentioned above, regardless of the shape, and according to this first embodiment, each panel 18 includes at least one registration bore 22 and is assembled on guide rods, as described above. However, according to another embodiment of the invention, panels 18 may be secured to each other (face to face) using an appropriate adhesive, such as contact cement, rubber cement, or any other type of adhesive appropriate for bonding a cellulose-based product to another cellulose-based product (e.g., paper to paper). As shown in FIG. 2, each panel 18 preferably includes a large cutout section 28, which may be any shape, but is shown in this example as a triangle with rounded apexes. This cutout 28 may be used in this embodiment to help align panels during assembly while they are being glued to each other, since in this embodiment, guide rods are not used. In such instance, cutout section 28 may be sized and shaped to slidingly fit onto a similarly sized and shaped alignment post (not shown) so that each panel may be stacked during gluing and curing. Thereafter, the entire assembly may be slide off the alignment post, once the adhesive cures. Of course, guide rods 26 and registration bores 22 described above may similarly be used to assemble and glue panels 18 to each other, with the guide rods later removed. Also, other alignment methods may be used to ensure that the final desired shelf shape is achieved. Cutout section 28 further reduces the weight and cost of the final shelf product since less material is required for each panel. The remaining cutout sections 28 of each panel 18 collectively form an elongated cavity 30 in the 3-D form (i.e., cat shelf 10) which, as shown in FIG. 10, may be left uncovered (that is, shelf 10 may not include end panels 52) and may be used to receive a scent-release material (not shown), such as catnip, a sound generator (not shown), or a gentle vibrating generator (not shown) which may be used to relax cat 14 and, in the case of the catnip, help get the cat acquainted to a newly installed shelf 10. Cavity 30 may further be used to hold a sample of the owner's clothing having the owner's scent. This may help the cat feel more comfortable using the present cat shelf.

Referring to FIGS. 4, 5, and 8, as mentioned above, each panel 18 includes an integrally formed cleat profile cutout 21. According to the invention, cutout 21 of each panel 18 becomes an elongated mounting cleat 32, when the individual panels 18 are stacked side-by-side (assembled). Cleat profile cutout 21 (and therefore elongated cleat 32) includes a recess 34 and an upper locking lip 36. Once the panels are assembled, the combined upper edges 17 of each panel become upper supporting surface 16, rear edges 35 become rear surface 20, and cleat profile cutout 21 becomes a 3-D elongated mounting cleat 32, which may run the full length of shelf 10, along rear surface 20, or a portion thereof (in such instance, some panels 18 would include cleat profile cutout 21, and some would not).

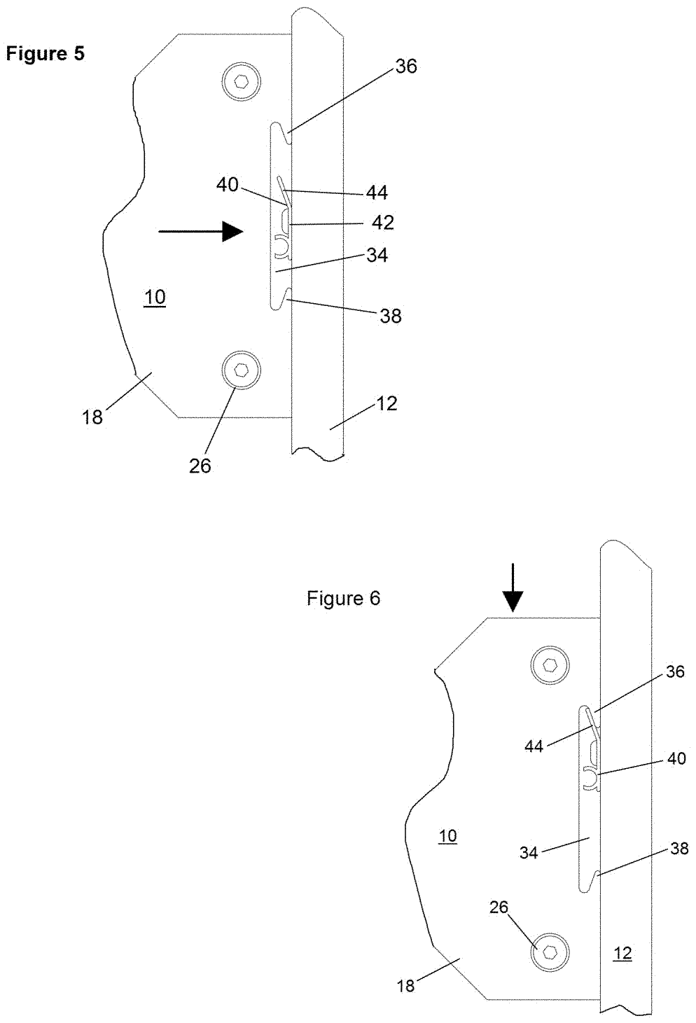

Cleat profile cutout 21 and when the panels are assembled, the elongated 3-dimensional mount-cleat 32 defines a recess 34, an upper locking lip 36 and may include an additional opposing lower locking lip 38. According to the present invention, only upper locking lip 36 is used to secure cat shelf 10 to wall surface 12. As described below, depending on the particular shape of cat shelf 10, and according to the invention, shelf 10 may be inverted and hung on wall surface 12 in an inverted orientation, wherein upper supporting surface reorients to an unusable lower surface. In which case, lower locking lip 38 flips to the top and effectively becomes upper locking lip 36. Whichever locking lip is on top of recess 34, and directed down, as shown in FIGS. 5, 6, 7 and 8, is the one that is used to mount shelf 10 to wall surface 12. Cleat profile cutout 21 of each panel (and collectively, when assembled, elongated cleat 32) is sized and shaped to snuggly engage with the wall cleat.

Referring now to FIG. 8, a wall mount cleat 40 is shown as an elongated shaped member and includes a mounting section 42 (which is meant to lay flat against a wall surface 12) and an angled engagement section 44 (which is angled out from wall surface 12 at a prescribed angle and distance). Mounting section 42 includes a plurality of openings 46 which are sized and shaped to receive appropriate fasteners to secure cleat 40 into wall surface 12, depending on the type of wall. The preferred wall-mounted cleat 40 is made from aluminum and its sectional shape is formed by a conventional extrusion process. The cleat extrusion is made in long lengths and later cross cut to form the shorter cleat. The length of the cleat will vary depending on the size of cat shelf 10. A preferred wall cleat 40 of this type is commercially available from Hangman Products, Inc of Woodland Hills, Calif.

Wall-cleat 40 may include a bubble-level channel 50 which is sized and shaped to snugly receive a bubble-level vial (not shown) so that wall mount cleat 40 effectively becomes a carpenter's level. This allows the user to quickly and easily level the wall mount cleat 40 against wall surface 12 without having to use an additional tool. Channel 50 includes arcuate walls that extend far enough to securely hold a bubble level vial when one is inserted into the channel. Wall-mount cleat 40 is preferably made from aluminum, but may be made from a variety of other materials, including metal, wood and plastic and may or may not include channel 50. At the very least, for wall-mount cleat 40 to work with the present cat shelf 10, cleat 40 must include angular engagement section 44 and a means for securing it to wall surface 12.

According to the invention, and referring to FIG. 6, wall-mounted cleat 40 is used to engage upper locking lip 36 to selectively secure cat shelf 10 to wall surface 12. Once wall-mounted cleat 40 is secured at a desired location against wall surface 12 using appropriate fasteners (brads, nails, screws, anchors, bolts, toggles, etc.) in a level orientation and with engagement section facing up towards the ceiling of the room, cat shelf 10 may be secured thereto. To do this, as shown in FIG. 5, a user lifts up shelf 10 and positions rear surface 20 against wall surface 12 so that recess 34 captures wall-mounted cleat 40. The user then slides shelf 10 along wall surface 12 until angled engagement section of wall mounted cleat 40 engages upper locking lip 36, as shown in FIG. 6. The nature of the angled surfaces of both the angled engagement section 44 and the angled upper locking lip 36 causes shelf 10 to be drawn into close frictional engagement with wall surface 12 as shelf 10 is pushed down, as illustrated by the arrow in FIG. 6. This mitigates any gap between shelf 10 and wall surface 12 when mounted, and further ensures a firm and solid securement of shelf 10 to the wall.

As shown in FIGS. 1, 2 and 3, cat shelf 10 may include end panels 52 which may be made from any appropriate material, such as metal, plastic, or cellulose-based product including wood and paper (e.g., cardboard). End panels 52 are preferably made from a strong and rigid material, such as aluminum, plastic or wood to help squeeze all panels 18 together, like a mechanic's vise. End panels 52 may provide a decorative appearance to shelf 10. Depending on the material, end panels may be provided with a decorative pattern printed thereon, or polished or otherwise colored, as desired.

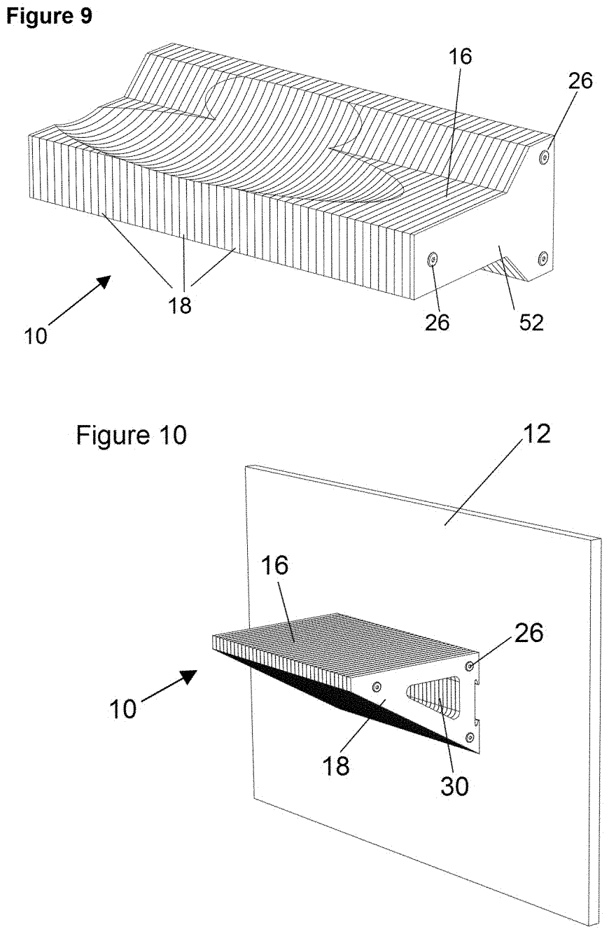

Referring to FIG. 9, and as mentioned above, each panel 18 used to make a particular shelf 10 may be uniquely shaped from the other panels 18 in the same shelf. This allows panels 18 to define and create a shelf having uniquely contoured surface, such as a depression or bowl shape on upper surface 16 that allows cat 14 to comfortably reside. Complex 3-D shapes may be easily created by simply cutting each panel 18 as required, to match the specific shape of the corresponding “slice” of the final shape. According to the invention, each panel 18 represents a slice or segment of the final shape, like how the shape of each individual slice of bread defines the overall shape of the loaf, when the slices are assembled together.

As shown in FIG. 8, a panel 18 is shown that includes recess 34, upper locking lip 36 and lower locking lip 38. As mentioned above, according to this embodiment, shelf 10 may be mounted upright, or inverted, simply by securing onto wall-mounted cleat whichever locking lip is oriented up. This arrangement allows for shelf 10 to provide two different upper surfaces 16 for the user to select. Each surface may be identical, in which case, shelf 10 would provide a user with a new surface, should the first surface become worn out as cat 14 scratches it, for example. Alternatively, upper and lower surfaces of shelf 10, according to this embodiment, may be shaped differently. Once surface may be a cushion while the inverted surface may provide a scratching surface. The cat owner may quickly and easily invert the shelf as desired or as necessary.

What is claimed is:

1. A laminate cat shelf having an upper supporting surface for supporting a cat, a rear surface, and being selectively mountable to a wall cleat, said wall cleat having a sectional profile and being horizontally secured to a wall surface, said laminate cat shelf comprising:
a plurality of panels, each of said panels conforming to a predetermined planar shape, and having a first planar surface and an opposing second planar surface, each of said panels defining a rear edge and an upper edge, each of said panels including a first cleat profile formed integrally along said rear edge; and
wherein, said panels are secured to each other, side by side, to form said laminate cat shelf, said panels being aligned so that said rear edge of each panel collectively forms said rear surface, said upper edge of each panel collectively forms said upper supporting surface, and said first cleat profile of each panel aligns with each other to collectively form said first cleat along said rear surface of said shelf, said first cleat being selectively engageable with said wall cleat to effectively secure said laminate cat shelf to said wall surface, allowing said upper supporting surface to support said cat.

2. The laminate cat shelf, according to claim 1, wherein said panels are secured to each other using an adhesive applied to at least one of said first and second planar surfaces.

3. The laminate cat shelf, according to claim 2, wherein said adhesive is a contact cement.

4. The laminate cat shelf, according to claim 1, wherein each of said panels further includes at least one registration bore, each of said bores collectively align with each other to form at least one elongated registration bore that passes longitudinally though said laminate cat shelf, and wherein an elongated mechanical fastener is positioned within said at least one elongated registration bore, said fastener being adapted to compress said panels forming said laminate cat shelf, securing said panels together.

5. The laminate cat shelf, according to claim 4, wherein said elongated mechanical fastener includes a threaded tube and two end screws.

6. The laminate cat shelf, according to claim 1, wherein said upper supporting surface is horizontal and flat.

7. The laminate cat shelf, according to claim 1, wherein said panels are made from a corrugate fiberboard having flutes which are oriented vertically and perpendicular to said upper surface.

8. The laminate cat shelf, according to claim 1, wherein said panels are made from a corrugate fiberboard having flutes which are oriented horizontally, and parallel to said upper surface.

9. The laminate cat shelf, according to claim 2, wherein said panels are made from a corrugate fiberboard having flutes which are oriented vertically and perpendicular to said upper surface, said flutes including open ends at said upper surface, said open ends of said flutes providing a scratch surface for a cat.

10. The laminate cat shelf, according to claim 1, wherein said upper supporting surface includes a concave shape.

11. A laminate cat shelf having an upper supporting surface for supporting a cat, a lower supporting surface to support said cat, a rear mounting surface, and being selectively mountable to a wall cleat, said wall cleat having a sectional profile and being horizontally secured to a wall surface, said laminate cat shelf comprising:
a plurality of panels, each of said panels conforming to a predetermined planar shape, and having a first planar surface and an opposing second planar surface, each of said panels defining a rear edge, an upper edge, and a lower edge, each of said panels including a first cleat profile formed integrally along said rear edge, and a second cleat profile, formed a predetermined distance from said first cleat profile, said first and second cleat profiles being identical in shape and mirror opposites of each other; and
wherein, said panels are secured to each other, side by side, to form said laminate cat shelf, said panels being aligned so that said rear edge of each panel collectively forms said rear mounting surface, said upper edge of each panel collectively forms said upper supporting surface, said first and second cleat profiles of each panel aligns with each other to collectively form said first and second cleats along said rear mounting surface of said shelf, said first cleat being selectively engageable with said wall cleat to effectively secure said laminate cat shelf to said wall surface, allowing said upper supporting surface to support said cat, said second cleat being selectively engageable with said wall cleat to secure said laminate cat shelf to said wall surface, allowing said lower supporting surface to be oriented upright to support said cat.

12. The laminate cat shelf, according to claim 11, wherein said panels are secured to each other using an adhesive applied to at least one of said first and second planar surfaces.

13. The laminate cat shelf, according to claim 12, wherein said adhesive is a contact cement.

14. The laminate cat shelf, according to claim 11, wherein each of said panels further includes at least one registration bore, each of said bores collectively align with each other to form at least one elongated registration bore that passes longitudinally though said laminate cat shelf, and wherein an elongated mechanical fastener is positioned within said at least one elongated registration bore, said fastener being adapted to compress said panels forming said laminate cat shelf, securing said panels together.

15. The laminate cat shelf, according to claim 14, wherein said elongated mechanical fastener includes a threaded tube and two end screws.

16. The laminate cat shelf, according to claim 11, wherein both said upper and lower supporting surfaces are horizontal and flat.

17. The laminate cat shelf, according to claim 11, wherein said panels are made from a corrugate fiberboard having flutes which are oriented vertically and perpendicular to both said upper and lower supporting surfaces.

18. The laminate cat shelf, according to claim 11, wherein said panels are made from a corrugate fiberboard having flutes which are oriented horizontally, and parallel to both said upper and lower supporting surfaces.

19. The laminate cat shelf, according to claim 12, wherein said panels are made from a corrugate fiberboard having flutes which are oriented vertically and perpendicular to both said upper and lower supporting surfaces, said flutes including open ends at said upper support surface and said lower supporting surface, said open ends of said flutes providing a scratch surface for a cat.

20. The laminate cat shelf, according to claim 1, wherein said upper supporting surface includes a concave shape.
